(19) United States
(12) Patent Application Publication
(10) Pub. No.: US 2021/0099915 A1
(43) Pub. Date: Apr. 1, 2021

(54) Mesh Networks for Wireless Communication

(71) Applicant: Phazr, Inc., Allen, TX (US)

(72) Inventors: Robert Clark Daniels, Allen, TX (US); Farooq Khan, Allen, TX (US)

(21) Appl. No.: 16/971,214

(22) PCT Filed: Feb. 20, 2019
(86) PCT No.: PCT/US2019/018848

§ 371 Date: Aug. 19, 2020

Related U.S. Application Data
(60) Provisional application No. 62/633,567, filed on Feb. 21, 2018.

(51) Int. Cl. H04W 28/20; H04W 84/12; H04W 84/22; H04W 72/04

(52) U.S. Cl. CPC H04W 28/20; H04W 72/0453; H04W 84/22; H04W 84/12

(57) ABSTRACT

A method for wireless communication includes assigning a first channel and a first bandwidth to a plurality of first links formed by user equipment (UEs) communicating with access points (APs) in the mesh network. The method further includes assigning a second bandwidth to a plurality of second links formed by the APs communicating with one another, wherein the second links are assigned different channels. The method also includes acquiring link data from the UEs and determining if mesh rate requirements are met with the assigned first bandwidth and the first channel. The method also includes determining a minimum bandwidth required for the first links and assigning the minimum bandwidth if mesh rate requirements are met. The method also includes assigning a second channel to the first links if mesh rate requirements are not met.

### BACKGROUND

The invention relates to wireless communications, and in particular relates to mesh networks for wireless communications.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems, whereas the 4G LTE systems provide wide area long-range connectivity both outdoors and indoors using dedicated infrastructure such as cell towers and backhaul to connect to the Internet.

As more people connect to the Internet, increasingly chat with friends and family, watch and upload videos, listen to streamed music, and indulge in virtual or augmented reality, data traffic continues to grow exponentially. In order to address the continuously growing wireless capacity challenge, the next generation of LAN and WAN systems are relying on higher frequencies referred to as millimeter waves in addition to currently used frequency bands below 7 GHz. The next generation of wireless WAN standard referred to as 5G New Radio (NR) is under development in the Third Generation Partnership Project (3GPP). The 3GPP NR standard supports both sub-7 GHz frequencies as well as millimeter wave bands above 24 GHz. In 3GPP standard, frequency range 1 (FR1) covers frequencies in the 0.4 GHz-6 GHz range. Frequency range 2 (FR2) covers frequencies in the 24.25 GHz-52.6 GHz range. Table 1 provides examples of millimeter wave bands including FR2 bands that may be used for wireless high data-rate communications. In the millimeter wave bands above 24 GHz, a time division duplexing (TDD) scheme is generally preferred. However, regulations in most parts of the World allow using other duplexing schemes including frequency division duplexing (FDD).

TABLE 1
below lists examples of millimeter wave bands.

| Bands [GHz] | Frequency [GHz] | Bandwidth [GHz] |
|---|---|---|
| 26 GHz Band | 24.25-27.5 | 3.250 |
| LMDS Band | 27.5-28.35 | 0.850 |
| | 29.1-29.25 | 0.150 |
| | 31-31.3 | 0.300 |
| 32 GHz Band | 31.8-33.4 | 1.600 |
| 39 GHz Band | 38.6-40 | 1.400 |
| 37/42 GHz Bands | 37.0-38.6 | 1.600 |

| | | | |
|---|---|---|---|
| | | 42.0-42.5 | 0.500 |
| 47 | GHz | 47.2-48.2 | 1.000 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| 150/160 | GHz | 151.5-155.5 | 12.50 |
| | | 155.5-158.5 | |
| | | 158.5-164 | |

Table 2 lists examples of FR1 bands in the 3GPP standard. We refer to the FR1 bands in the 3GPP standard, unlicensed 2.4 GHz and 5 GHz bands, 5.925-6.425 GHz and 6.425-7.125 GHz bands and any other spectrum band below 7 GHz as sub-7 GHz spectrum. The duplexing schemes used in the sub-7 GHz spectrum, among others, can be time division duplexing (TDD), frequency division duplexing (FDD), supplemental downlink (SDL) or supplemental uplink (SUL).

TABLE 2
Examples of FR1 bands in 3GPP

| 5G-RAN | | | |
|---|---|---|---|
| Frequency | Uplink Frequency | Downlink Frequency | Duplex |
| Band | band | band | Mode |
| n1 | 1920 MHz-1980 MHz | 2110 MHz-2170 MHz | FDD |
| n3 | 1710 MHz-1785 MHz | 1805 MHz-1880 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n41 | 2496 MHz-2690 MHz | 2496 MHz-2690 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n77 | 3300 MHz-4200 MHz | N/A | TDD |
| n78 | 3300 MHz-3800 MHz | N/A | TDD |
| n79 | 4400 MHz-5000 MHz | N/A | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

In addition to serving mobile devices, the next generation of wireless WAN systems using millimeter wave and sub-7 GHz spectrum is expected to provide high-speed (Gigabits per second) links to fixed wireless broadband routers installed in homes and commercial buildings.

As mentioned, a wireless LAN (WLAN or Wi-Fi) is typically used indoors as a short-range wireless extension of wired broadband systems. A WLAN enables wireless networking functionality between an access point (AP) and one or more user equipment (UE) (also referred to herein as STA). A UE may access an external wide area network such as the Internet via an AP through wireless means.

FIG. 1 conceptually illustrates a WLAN 100 which can be deployed in, for example, a home, office, airport or a store. The WLAN 100 includes an AP 104 and a plurality of UEs 108A-108C. The UEs 108A-108C communicate with the AP 104 through wireless means. The AP 104 is connected to an external network such as the Internet 112. The AP 104 provides external network access to the UEs 108A-108C through wireless means.

One limitation of the traditional WLAN is that means are not provided to network together multiple APs, and means are not provided to allow UEs to connect to multiple APs simultaneously. A further limitation of the traditional WLAN is that means are not provided to allow to network UEs that are not connected to the same AP. As a result, coverage of traditional WLAN deployments is often unsatisfactory.

To overcome coverage limitation of the traditional WLAN, mesh networks have been deployed as an extension of wide area wireless networks. The mesh networks can be deployed in, for example, an office, home, store or airport.

FIG. 2 conceptually illustrates a mesh network 200. The dashed lines represent mesh backhaul connections and solid, double arrow lines represent AP to STA links (i.e., AP to UE links) The mesh network 200 is enabled through AP-to-AP communication. In FIG. 2, Non-AP STAs are client devices, such as, for example UEs, mobile phones, laptop computers, and Mesh APs are mesh access points. The mesh network 200 relies on cable modem as a backhaul.

FIG. 3 conceptually illustrates a mesh network 300 which is enabled through STA to STA (i.e., UE to UE) communication. In FIG. 3, Mesh STAs are client devices capable of STA to STA communication to enable mesh network connectivity. If a mesh network is enabled through STA to STA communication, mesh devices also need to include separate AP functionality as a means to connect non-AP STAs. The mesh network 300 also relies on cable modem as a backhaul.

When a mesh network is installed in a building, mesh wireless coverage may extend outside and to the immediate adjacent area of the building. If adjacent buildings in an area or neighborhood have active mesh networks, the coverage regions may overlap.

FIG. 4 illustrates overlapping mesh coverage which causes interference. Referring to FIG. 4, a base station 404 (also referred to as Fixed Wireless Access (FWA)) provides wireless coverage in an area represented by a circle 408. Buildings represented by hashed squares have mesh networks that provide mesh coverage in regions represented by dotted lines. Due to overlapping mesh coverage, several regions are subject to interference.

### SUMMARY

Various aspects of the present disclosure are directed to mesh networks for wireless communications. In one aspect of the present disclosure, a method for wireless communication in a mesh network includes assigning a first channel and a first bandwidth to a plurality of first links formed by user equipment (UEs) communicating with access points (APs) in the mesh network. The method further includes assigning a second bandwidth to a plurality of second links formed by the APs communicating with one another in the mesh network, wherein the second links are assigned different channels. The method also includes acquiring link data from the UEs and determining if mesh rate requirements are met with the assigned first bandwidth and the first channel. The method also includes determining a minimum bandwidth required for the first links and assigning the minimum bandwidth if mesh rate requirements are met. The method also includes acquiring link data from the UEs and determining if mesh rate requirements are met with the assigned first bandwidth and the first channel. The method also includes assigning a second channel to the first links if mesh rate requirements are not met.

In an additional aspect of the disclosure, a computer program product for wireless communication in a mesh network includes a non-transitory computer-readable medium having program code recorded thereon. The program code includes code to assign a first channel and a first bandwidth to a plurality of first links formed by user equipment (UEs) communicating with access points (APs) in the mesh network. The program code also includes code to assign a second bandwidth to a plurality of second links formed the APs communicating with one another in the mesh network, wherein the second links are assigned different channels, and wherein the UEs in the mesh network access a wide area cellular network via the APs. The program code also includes code to acquire link data from the UEs, and also includes code to determine if mesh rate requirements are met with the assigned first bandwidth and the first channel. The program code also includes code to determine a minimum bandwidth required for the first links. The program code also includes code to acquire link data from the UEs, and also includes code to determine if mesh rate requirements are met with the assigned first bandwidth and the first channel. The program code also includes code to assign a second channel to the first links.

In an additional aspect of the disclosure, a method for wireless communication in a mesh network includes assigning a first channel and a first bandwidth to a plurality of first links formed by user equipment (UEs) communicating with access points (APs) in the mesh network. The method further includes assigning a second bandwidth and a second channel to a first AP, wherein the second channel does not overlap with the first channel. The method further includes acquiring link data from the first AP and determining if link utilization is greater than a predetermined value. The method also includes assigning a third channel to the first AP if the link utilization is greater than the predetermined value. The method also includes operating the first AP on the second channel if the link utilization is not greater than the predetermined value. The method also includes transmitting the link data to a central controller.

### BRIEF DESCRIPTION OF THE DRAWINGS

FIG. 1 conceptually illustrates an example of a WLAN.

FIGS. 2-3 conceptually illustrate mesh networks.

FIG. 4 conceptually illustrates overlapping mesh coverage.

FIG. 5 is a block diagram conceptually illustrating a wireless network.

FIG. 6 is a block diagram conceptually illustrating a wireless network.

FIG. 7 is a functional block diagram conceptually illustrating example blocks executed to implement one aspect of the present disclosure.

FIG. 8 is a functional block diagram conceptually illustrating example blocks executed to implement one aspect of the present disclosure.

FIG. 9 is a functional block diagram conceptually illustrating example blocks executed to implement one aspect of the present disclosure.

FIG. 10 is a functional block diagram conceptually illustrating example blocks executed to implement one aspect of the present disclosure.

FIG. 11 is a functional block diagram conceptually illustrating example blocks executed to implement one aspect of the present disclosure.

FIG. 12 is a functional block diagram conceptually illustrating example blocks executed to implement one aspect of the present disclosure.

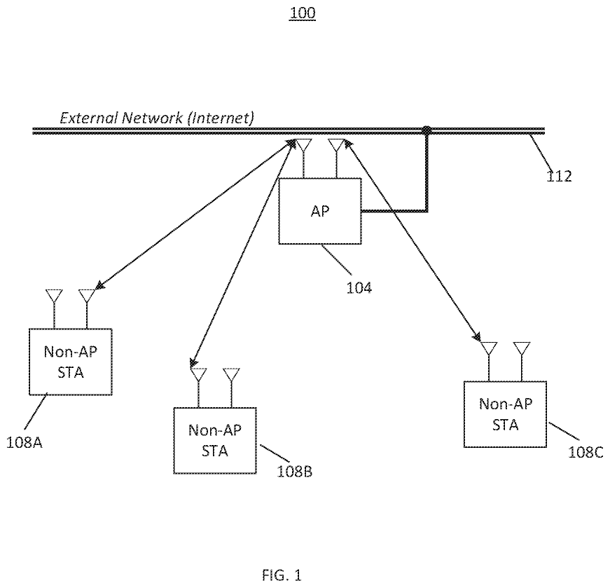

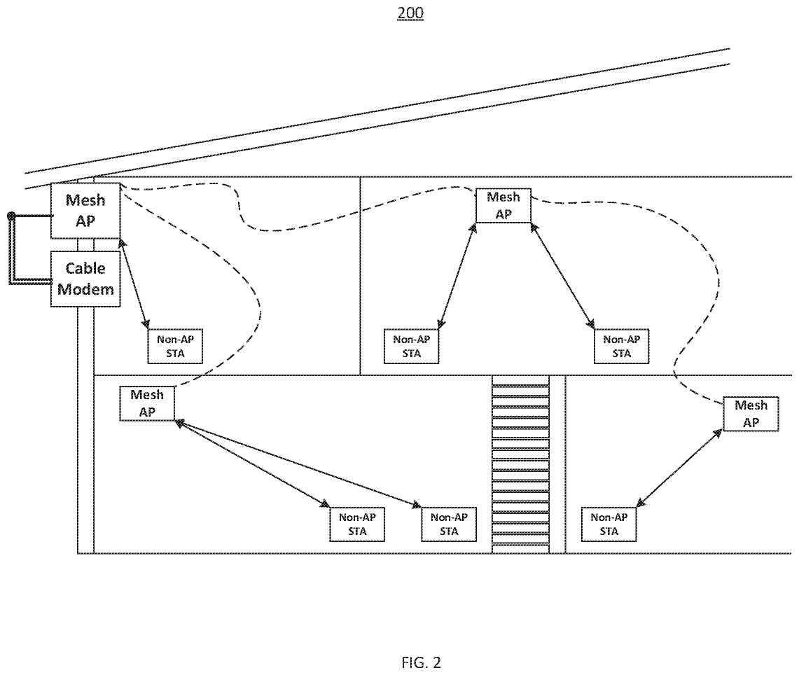

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well known structures and components are shown in block diagram form in order to avoid obscuring such concepts.

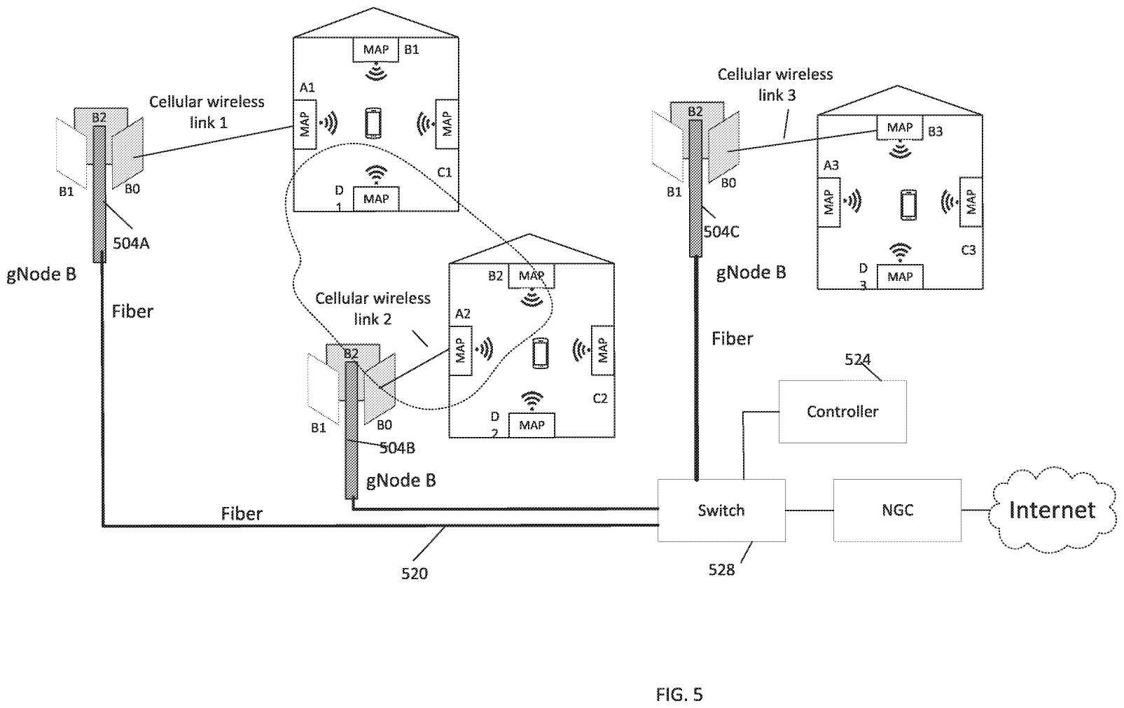

FIG. 5 is a block diagram conceptually illustrating a wireless network 500 for communication. The wireless network 500 may, for example, be a 4G LTE or a 5G network. The wireless network 500 includes a number of base stations 504A-504C, which are connected to a wide area network such as the Internet via a wired connection 520. The base station 504A communicates with a mesh access point (MAP) A1 over a cellular wireless link 1, the base station 504B communicates with a mesh access point (MAP) A2 over cellular wireless link 2, and the base station 504C communicates a mesh access point (MAP) B3 over cellular wireless link 3. A first mesh network comprises mesh access points A1, B1, C1 and D1, a second mesh network comprises mesh access points A2, B2, C2 and D2, and a third mesh network comprises mesh access points A3, B3, C3 and D3. The mesh access points within a mesh network communicates with each other using mesh wireless links. The spectrum may be shared between the mesh network links and the wide area wireless network links. The mesh networks serve communication devices and UEs such as, for example, smartphones, laptop computers, desktop computers, augmented reality/virtual reality (AR/VR) devices, IoT devices.

Referring to FIG. 5, a central controller 524 is connected to the base stations 504A-504C via a switch 528. The central controller 524 manages, among others, spectrum sharing between wide area wireless network and the mesh networks. For example, the mesh access points D1, A2 and B2 and the cellular wireless link 2 may interfere with each other. The controller 524 can allocate different orthogonal channels for the wireless link 2 and the mesh access points D1, A2 and B2 to avoid interference. The controller 524 can also implement policy changes in the mesh networks based on channel conditions and loading on the wide-area wireless links.

Although, the mesh access points A1-D1, A2-D2, and A3-D3 are installed in buildings to provide in-building wireless mesh network capability, the mesh access points may be configured to provide wireless mesh network capability inside a moving vehicle such as a car, a bus or a train.

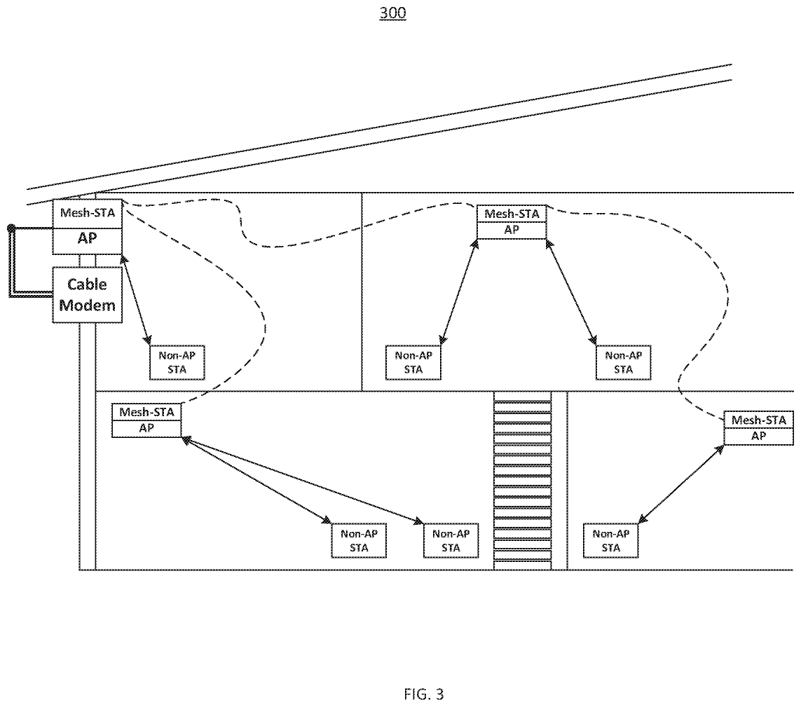

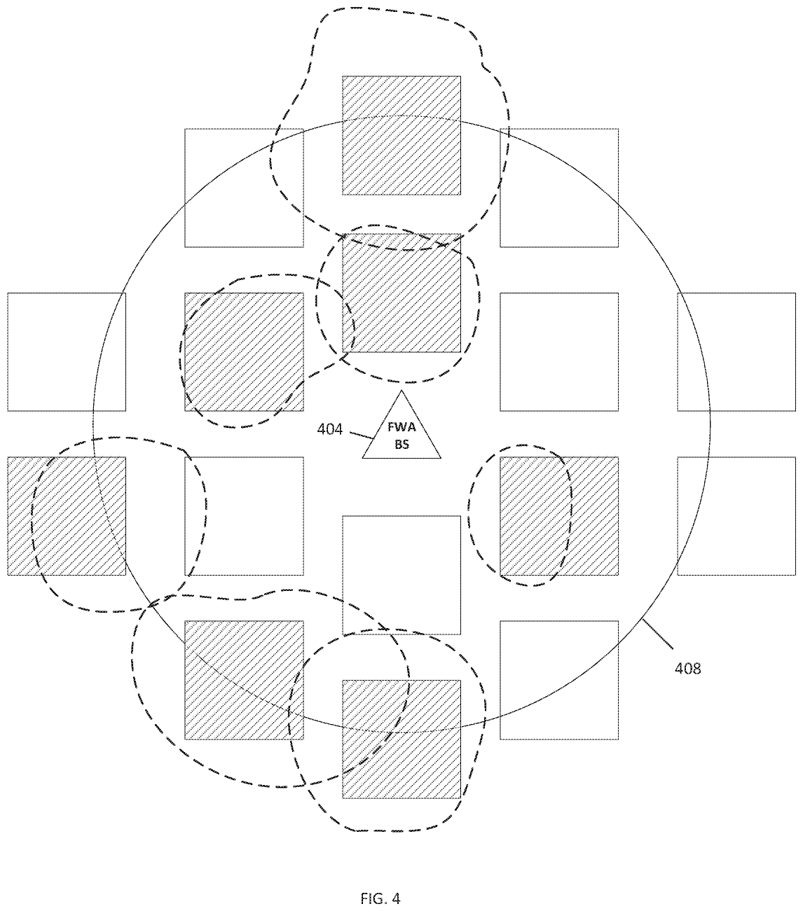

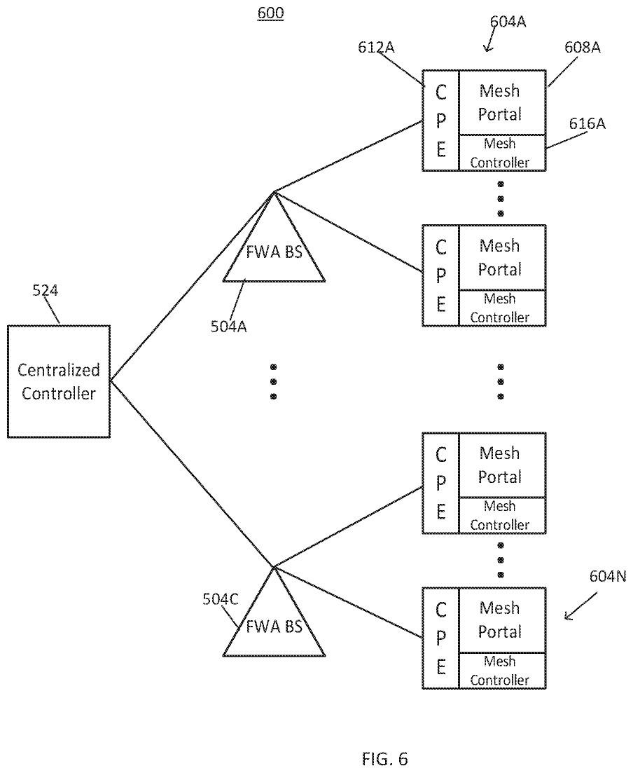

FIG. 6 is a block diagram conceptually illustrating a wireless network 600 in accordance with one aspect of the present disclosure. In the network 600, the central controller 524 manages spectrum sharing between a wide area wireless network and mesh networks. The central controller 524 assigns or allocates bandwidth and channels to base stations 504A-504C and mesh APs 604A-604N. In FIG. 3, the base stations 504A-504C are referred as fixed wireless access base stations (FWA BS) 504A-504C.

The controller 524 can also implement policy changes in the mesh networks based on channel conditions and loading on the wireless links. The central controller 524 may, for example, be a rack-mounted server which contains software. The central controller 524 may be connected to the base stations 504A-504C via a wired connection.

In one embodiment, the mesh APs 604A-604N include mesh portal devices and customer premise equipment (CPEs). For example, the mesh AP 604A includes a mesh portal device 608A and a CPE 612A. In some embodiments, the CPE 612A may be integrated into the mesh AP 604A, but in other embodiments the CPE 612A may be a separate device. The CPE 612A establishes wireless link with the base station 504A, thereby allowing the mesh portal device 608A to access an external network such as, for example, a 5G or a 4G LTE wireless network. The mesh portal device 608A may include a mesh controller 616A which manages the mesh network.

In operation, the central controller 524 receives data from the base stations 504A-504C and also from the mesh APs 604A-604N. The central controller 524 may, for example, receive data relating to wireless link metrics (e.g., signal strength, bit error rate, data throughput, routing information) and may also receive data indicating configuration settings used for the base stations 504A-504C and for the mesh APs 604A-604N. Based on the data, the central controller 524 can configure the base stations 504A-504C and the mesh APs 604A-604N. The central controller 524 may send one or more configuration parameters including link bandwidth, link carrier frequency, transmit power, antenna tilt, and quality of service for different traffic types to the base stations 504A-504C for configuration purposes.

According to disclosed embodiments, the mesh controller 616A may be computer program code residing in an embedded system such as, for example, a WLAN radio system on a chip. The central controller 524 may access and manage the mesh controller 616A via the base station 504A and may adjust configuration settings of the mesh controller 616A to control traffic routes, channel selections, channel bandwidth, and channel power, etc.

According to some disclosed embodiments, bandwidth and channels (e.g., center frequencies) are dynamically assigned or allocated to the UEs in the mesh network. The mesh controller 616A, for example, may assign or allocate bandwidth and channels to the UEs based on one or more criteria. For example, the channels may be assigned to prevent interference between various link categories that include: link between access point (AP) to non-AP devices (e.g., 802.11 compatible device); link between STA devices to STA devices (on Mesh Portal and other mesh devices); link between AP (e.g., 802.11 compatible AP) to non-AP STA devices (e.g., 802.11 compatible STA devices).

According to some disclosed embodiments, the dynamic allocation of bandwidth and channel (i.e., center frequency) is based on channel utilization. For example, an AP device in the mesh network may measure the percentage of time a channel is occupied by other links on a fixed interval after categorizing traffic types. The traffic types may for example include: absence of traffic (when a receiver does not detect signals over a pre-defined power threshold); external traffic (when an AP receives packets that are not intended for the AP); internal traffic (when an AP receives packets that are intended for the AP or when the AP transmits packets). UEs (e.g., STA devices) measure their own contribution to link utilization and provide utilization measurements to the mesh controller for the traffic categories. However, external traffic may include STA to STA links in the mesh that do not involve the STA taking the measurements. The STA utilization measurements may be aggregated for a total channel utilization, and based on the channel utilization measurements, bandwidth and channel may be allocated to the STAs.

According to some disclosed embodiments, the dynamic allocation of bandwidth and channel may be based on link quality and bandwidth requirements. For example, a receiving UE (i.e., receiving STA) in a STA to STA link may measure average received power and noise floor. This is also referred to as signal to interference plus noise ratio (SINR).

The ratio of average received power and noise floor may be used to determine an average signal to noise ratio (SNR), which may be used to allocate bandwidth and channel among the STAs. For example, a larger bandwidth may be assigned to a link if SNR is greater than a predetermined value because increasing bandwidth also noise floor.

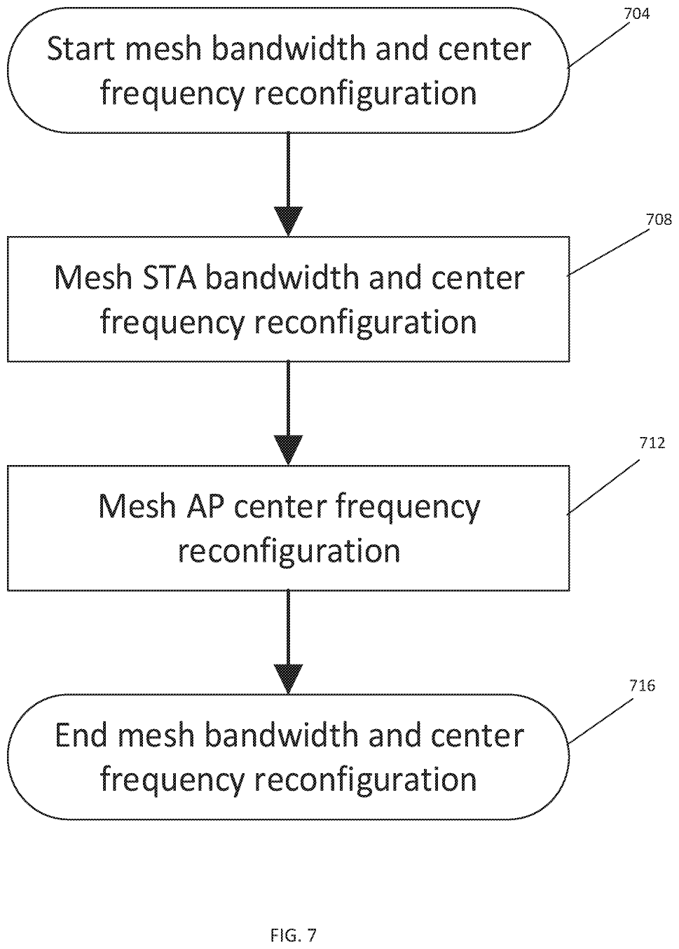

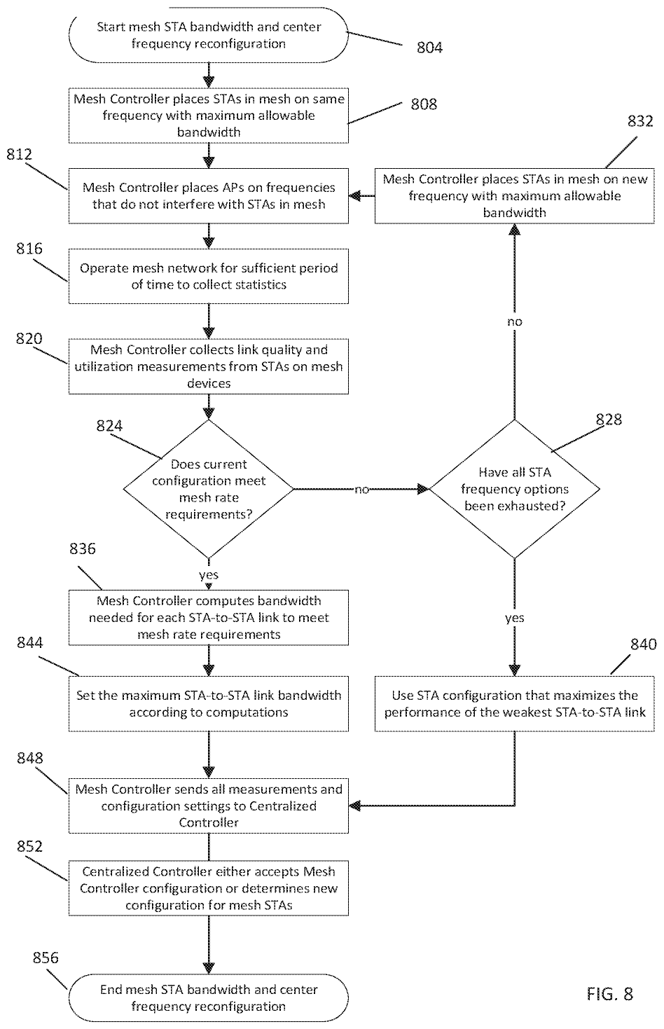

According to some disclosed embodiments, the mesh controller first allocates frequency and bandwidth to STA to STA links (i.e., UE to UE links) in order to optimize performance of the STA to STA links. In other embodiments, the central controller may allocate frequency and bandwidth to the STA to STA links. The mesh controller may allocate STA to STA links a same center frequency while access points (APs) may be allocated different center frequencies. FIG. 7 is a functional block diagram illustrating example blocks executed to implement one aspect of the present disclosure. The flow starts in block 704, and in block 708 the mesh controller reconfigures STA (i.e., UE) bandwidth and center frequencies. In block 712, the mesh controller reconfigures AP bandwidth and center frequencies, and in block 716 the flow ends. In other embodiments, the aforementioned steps shown in FIG. 7 may be executed by the central controller instead of the mesh controller. A detailed description of blocks 704-716 are provided below in conjunction with FIG. 8.

FIG. 8 is a functional block diagram illustrating example blocks executed to implement one aspect of the present disclosure. The flow begins in block 804, and in block 808 the mesh controller initializes STAs (i.e., UEs) with a selected center frequency. According to some embodiments, the mesh controller initializes the STAs with the maximum allowable bandwidth, since link utilization measurements using the maximum bandwidth setting provide a worst-case scenario. Maximum allowable bandwidth depends on: (1) maximum bandwidth supported by a device; (2) maximum bandwidth allowable by communication protocol standard; (3) maximum bandwidth allowable by regulatory constraints.

In block 812, the mesh controller places APs on frequencies that do not interference with mesh STAs. In some embodiments, except when unavoidable the mesh controller places the STAs on different channels than APs. In block 816, the mesh operates for a predetermined period of time, and in block 820 the mesh controller collects link utilization and link quality statistics from the STAs. Link quality statistics may, for example, be statistics of received power, noise floor, SNR, EVM and packet error rate.

In decision block 824, the mesh controller determines if the current configuration meets mesh rate requirements. Given a link utilization percentage available to each STA-to-STA link combined with the maximum supported rate achieved through link adaptation, the mesh controller determines if each STA to STA link meets mesh rate requirements in accordance with, for example, customer requirements. If the configuration does not meet requirements, in block 828 the mesh controller determines if all STA frequency options are exhausted. If all frequency options are not exhausted and more frequencies are available for testing, in block 832 the mesh controller places the STAs on a new frequency.

If the configuration meets requirements, in block 836 the mesh controller optimizes the configuration by computing bandwidth needed for each STA to STA link to meet mesh rate requirements. The mesh controller may use a table that provides a maximum bandwidth required to meet a given mesh rate requirement. For example, the mesh controller may optimize the configuration by minimizing the bandwidth in each STA to STA link. This minimization can occur by the best supported rate provided by link adaptation and by measured SNR. In some embodiments, a table may be used to determine the best supported rate for reduced bandwidth.

In block 828, if the mesh controller determines that all frequency options are exhausted, in block 840 the mesh controller selects an STA configuration that maximizes performance of the weakest STA to STA link. For example, the mesh controller may select a channel that maximizes SNR of the worst link in the mesh network.

In some embodiments, in block 844 the mesh controller sets STA to STA links using the computation. In block 848, the mesh controller may send measurements and configurations settings to a central controller, and in block 852 the central controller may accept the configurations or determine new configurations for the STAs. The flow ends in block 856. In some embodiments, one or more of the aforementioned steps shown in FIG. 8 may be executed by the central controller instead of the mesh controller.

In some embodiments, after the link bandwidth determination is made for each STA-to-STA link, the mesh controller may set the bandwidth and frequency until the next reconfiguration issued by the mesh controller.

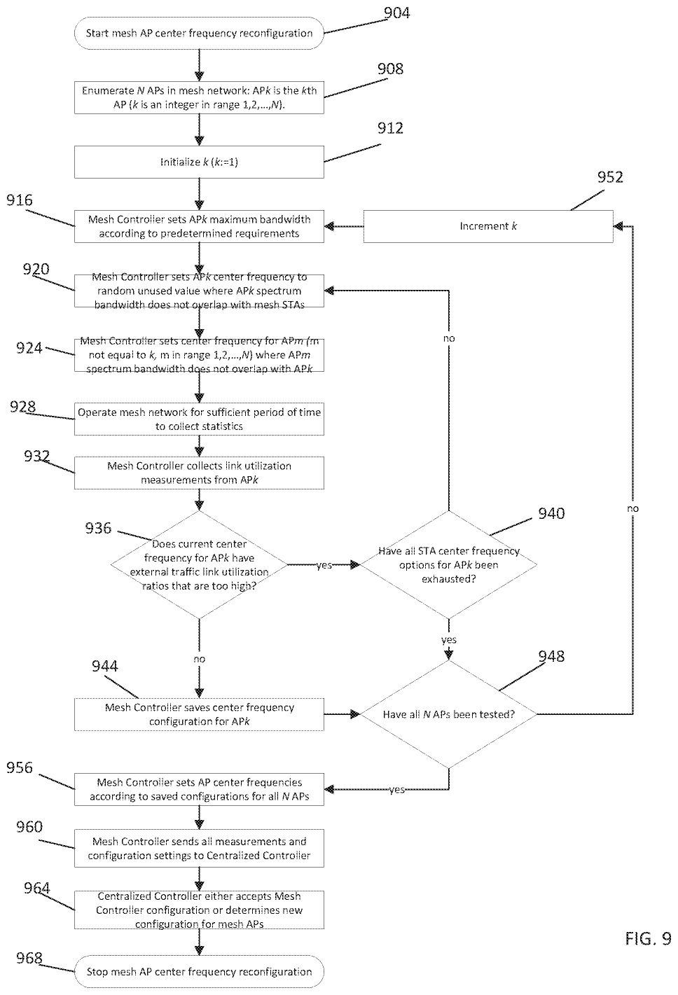

FIG. 9 is a functional block diagram illustrating example blocks executed to implement one aspect of the present disclosure. More specifically, FIG. 9 shows example blocks executed for reconfiguration of mesh AP bandwidth and center frequency.

In one aspect, the mesh controller selects center frequency for each AP in the mesh network independently in a round robin fashion, and interference between APs can be mitigated by load balancing in the mesh network. The process starts in block 904, and in block 908, the mesh controller enumerates N APs in the mesh network, where AP_{K} is the kth AP and K is an integer in a range 1, 2, . . . , N, and in block 912, the mesh controller initializes K.

In block 916, the mesh controller sets a maximum bandwidth for AP_{K}. For example, the mesh controller may set a maximum bandwidth for AP_{K} in accordance with one or more requirements. In block 920, the mesh controller sets AP_{K} center frequency to a random unused value. For example, the mesh controller may set AP_{K} center frequency to a random unused value where AP_{K} spectrum bandwidth does not overlap with mesh STAs.

In block 924, the mesh controller sets the center frequency for AP_{M} (M not equal to K), wherein AP_{M} spectrum bandwidth does not overlap with AP_{K}. In block 928, the mesh network operates for a predetermined time period to collect statistics, and in block 932 the mesh controller collects link utilization measurements from AP_{K}.

In decision block 936, the mesh controller determines if the center frequency for AP_{K} has a traffic link utilization ratio that is greater than a predetermined value (e.g., 0.5). Traffic link utilization ratio indicates the ratio of traffic on the current channel as part of the mesh network and traffic from other sources.

If the center frequency for AP_{K} has traffic link utilization ratio greater than a predetermined value, in decision block 940 the mesh controller determines if all center frequency options for AP_{K} are exhausted. If STA center frequency options for AP_{K} are not exhausted, the flow returns to block 920. In block 936, if traffic utilization ratio is not greater than a predetermined value, the mesh controller saves center frequency configurations in block 944. In decision block 948, the mesh controller determines if all APs have been tested. If all APs have not been tested, in block 952, the mesh controller increments K and the flow returns to block 916. If all APs have been tested, in block 956 the mesh controller sets APs' center frequencies according to saved configurations. The mesh controller may end the AP reconfiguration process after sending measurements and configurations to the central controller in block 960. In block 964, the central controller either accepts the configurations or override the configurations and determines new configurations, and the flow ends in block 968. In some embodiments, some or all of the aforementioned steps executed or performed by the mesh controller may instead be executed or performed by the central controller.

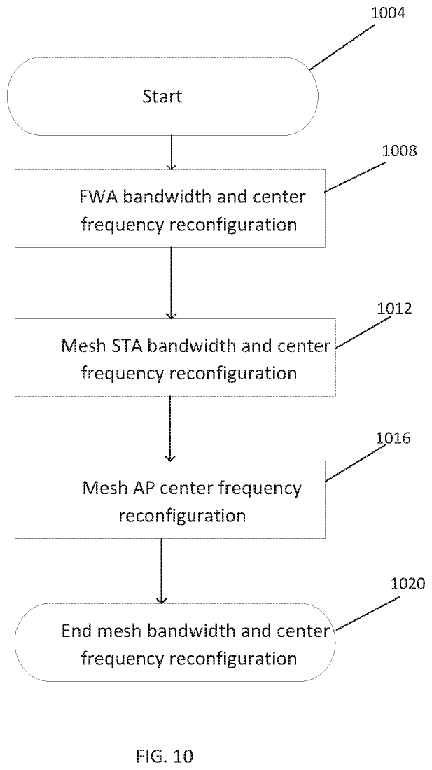

FIG. 10 is a functional block diagram illustrating example blocks executed to implement one aspect of the present disclosure. More specifically, FIG. 10 illustrates example blocks executed for reconfiguration of a wide area cellular wireless network (WACWN) link and a mesh network according to disclosed embodiments. The mesh network may, for example, be one of the mesh networks illustrated in FIG. 5.

In one aspect, since the WACWN link is considered a backbone link, the bandwidth and center frequencies of the WACWN link is configured first in order to prioritize its performance. The process begins in block 1004, and in block 1008, the central controller configures bandwidth and center frequencies for the WACWN link (also referred to as FWA link). In block 1012, the central controller (or the mesh controller) configures bandwidth and center frequencies for mesh STAs (UEs). Next, in block 1016, the central controller (or the mesh controller) configures bandwidth and center frequencies for mesh APs, and the process ends in block 1020. It will be apparent that the foregoing method is applicable to fixed wireless systems as well as mobile systems, and the foregoing steps may be executed or performed by either the central controller or the mesh controller.

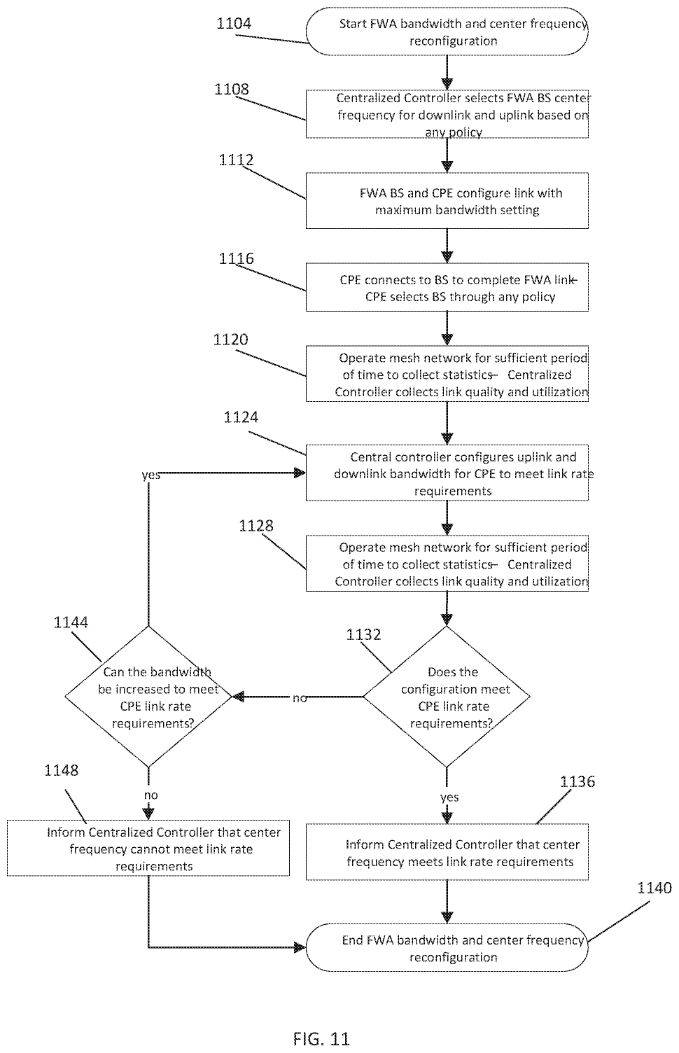

FIG. 11 is a functional block diagram illustrating example blocks executed to implement one aspect of the present disclosure. The process starts in block 1104, and in block 1108 a central controller may select center frequencies for a base station.

In block 1112, the central controller sets a maximum bandwidth for the link between the mesh AP and the base station. For example, the central controller may configure the link between the CPE in the AP with a maximum available bandwidth, and in block 1116 the AP (or CPE) connects to the base station to complete the external link. The mesh network operates for a predetermined period of time in block 1120. The mesh network may be operated for a sufficient period of time to allow the central controller to collect link quality and utilization data.

In block 1124, the central controller configures uplink and downlink bandwidth for the AP (or CPE) to meet rate requirements. In block 1128, the mesh network operates for a sufficient period of time to collect statistics. For example, the mesh network may operate for a predetermined period of time in order to enable the central controller to collect link quality and utilization data.

In decision block 1132, the central controller determines if the configuration meets link requirements. In other words, the central controller determines if the configuration delivered link rate as expected. If the central controller determines that link requirement is met, the reconfiguration process may end. More specifically, in block 1136, the mesh controller may inform the central controller that the center frequency meets link requirement and the reconfiguration process may be ended in block 1140.

If in block 1132, the central controller determines that AP or CPE link requirement is not met, in decision block 1144 the central controller determines if the bandwidth may be increased to meet link requirements. If the bandwidth may be increased, the flow returns to block 1124. Otherwise, the reconfiguration process may be ended in block 1140. In some embodiments, the mesh controller may inform the central controller that configuration does not meet rate requirements in block 1148.

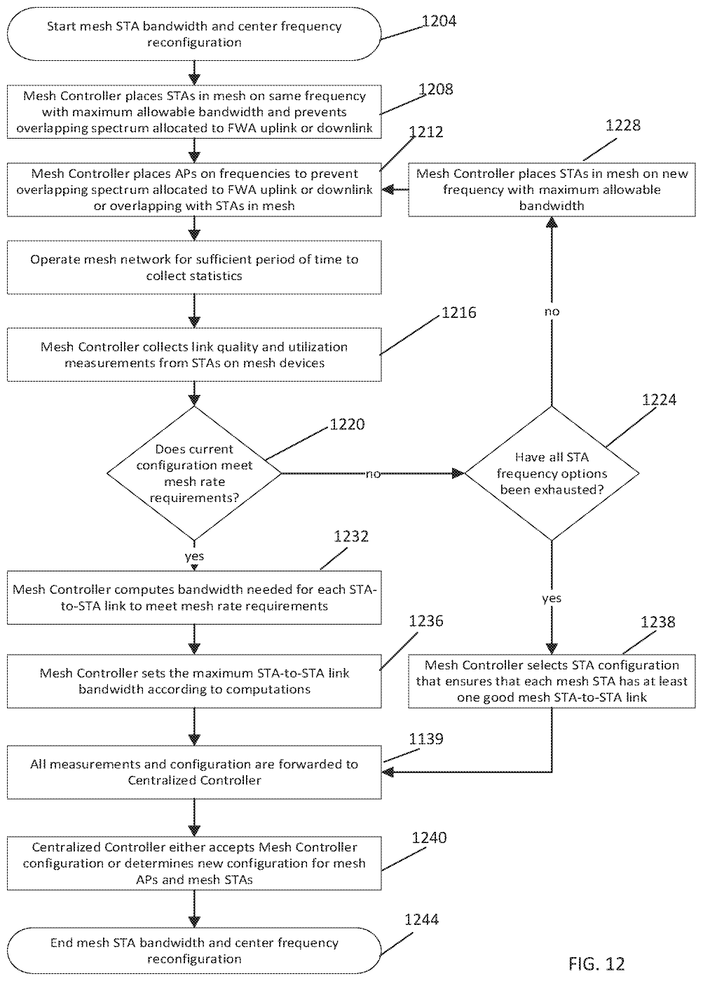

FIG. 12 is a functional block diagram illustrating example blocks executed to implement one aspect of the present disclosure. The flow begins in block 1204, and in block 1208 the mesh controller initializes STAs (i.e., UEs) by placing them on a same frequency with maximum allowable bandwidth. For example, the mesh controller may place the STAs (UEs) on a same frequency with maximum allowable bandwidth that does not overlap with the spectrum allocated to the radio base station for uplink and downlink.

In block 1212, the mesh controller places APs on frequencies that do not overlap with the spectrum allocated to the radio base station and also do not overlap with the spectrum allocated to the STAs. The remaining blocks 1216-1244 are same as the blocks 812-856 and thus will not be described again.

Those of skill would appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above in general terms of their functionality. Whether such functionality is implemented as hardware or software depends upon the particular application and design constraints imposed on the overall system Those of skill may implement the described functionality in varying ways for each particular application, but such implementation decision should not be interpreted as causing a departure from the scope of the present disclosure.

The various illustrative logical blocks, modules and circuits described in connection with the disclosure herein may be implemented or performed with a general purpose processor, a digital signal processor (DSP), an application specific integrated circuit (ASIC), a field programmable gate array (FPGA), or other programmable logic device, transistor logic, discrete hardware components, or any combination thereof designed to perform the functions described herein. A general purpose processor may be a microprocessor, a controller, a microcontroller or a state machine.

The steps of a method or algorithm described in connection with the disclosure herein may be embodied in hardware, in a software module executed by a processor or in a combination of the two. A software module may reside in RAM memory, flash memory, ROM memory, EPROM memory, registers, hard disk, a removable disk, a CD-ROM, or any other form of storage known in the art. An exemplary storage medium is coupled to the processor such that the processor can read information from, and write information to, the storage medium. In the alternative, the storage medium may be integral to the processor. The processor and the storage medium may reside in an ASIC, or the processor and the storage medium may reside in discrete components.

In one or more exemplary designs, the functions described may be implemented in hardware, software, firmware, or any combination thereof. If implemented in software, the functions may be stored on or transmitted over as one or more instructions or code on a computer-readable medium. Computer-readable medium includes both non-transitory computer storage media and communication media including any medium that facilitates transfer of a computer program from one location to another. A non-transitory storage media may be any available media that can be accessed by a general purpose or special purpose computer. By way of example, and not limitation, such non-transitory computer readable media can comprise RAM, ROM, EEPROM, CD-ROM, optical disk storage, magnetic disk storage, DVD, or any other medium that can be used to store program code means in the form of instructions or data structures and that can be accessed by a general purpose or special purpose processor. Any connection is termed a computer-readable medium. If the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk, as used herein, includes CD, laser disc, optical disc, DVD, floppy disk and other disks that reproduce data.

The previous description of disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

1. A method for wireless communication in a mesh network, comprising:
assigning a first channel and a first bandwidth to a plurality of first links formed by user equipment (UEs) communicating with access points (APs) in the mesh network; and
assigning a second bandwidth to a plurality of second links formed the APs communicating with one another in the mesh network, wherein the second links are assigned different channels.

2. The method of claim 1, further comprising assigning the first bandwidth to the first links prior to assigning the second bandwidth to the second links.

3. The method of claim 1, further comprising:
acquiring link data from the UEs and determining if mesh rate requirements are met with the assigned first bandwidth and the first channel; and
if mesh rate requirements are met, determining a minimum bandwidth required for the first links and assigning the minimum bandwidth.

4. The method of claim 1, further comprising:
acquiring link data from the UEs and determining if mesh rate requirements are met with the assigned first bandwidth and the first channel; and
if mesh rate requirements are not met, assigning a second channel to the first links.

5. The method of claim 4, further comprising transmitting the link data to a central controller.

6. The method of claim 1, wherein the UEs in the mesh network communicate with a radio base station via the APs over a wide area cellular network.

7. The method of claim 3, wherein the minimum bandwidth is determined from a signal to noise ratio of the first links.

8. The method of claim 1, wherein the UE is a mobile phone.

9. The method of claim 1, wherein the UEs communicate with a radio base station via the APs over the wide area cellular network.

10. A non-transitory computer-readable medium having program code recorded thereon, the program code comprising:
program code to assign a first channel and a first bandwidth to a plurality of first links formed by user equipment (UEs) communicating with access points (APs) in the mesh network; and
program code to assign a second bandwidth to a plurality of second links formed the APs communicating with one another in the mesh network, wherein the second links are assigned different channels, and wherein the UEs in the mesh network access a wide area cellular network via the APs.

11. The non-transitory computer-readable medium of claim 10, further comprising:
program code to acquire link data from the UEs and to determine if mesh rate requirements are met with the assigned first bandwidth and the first channel; and
program code to determine a minimum bandwidth required for the first links.

12. The non-transitory computer-readable medium of claim 10, further comprising:
program code to acquire link data from the UEs and to determine if mesh rate requirements are met with the assigned first bandwidth and the first channel; and
program code to assign a second channel to the first links.

13. The non-transitory computer-readable medium of claim 11, further comprising program code to determine the minimum bandwidth from a signal to noise ratio of the first links.

14. A method for wireless communication in a mesh network, comprising:
assigning a first channel and a first bandwidth to a plurality of first links formed by user equipment (UEs) communicating with access points (APs) in the mesh network;
assigning a second bandwidth and a second channel to a first AP, wherein the second channel does not overlap with the first channel;
acquiring link data from the first AP and determining if link utilization is greater than a predetermined value;
assigning a third channel to the first AP if the link utilization is greater than the predetermined value; and
operating the first AP on the second channel if the link utilization is not greater than the predetermined value, wherein the UEs in the mesh network access a wide area cellular network via the APs.

15. The method of claim 14, further comprising transmitting the link data to a central controller.

16. The method of claim 14, wherein the UE is a mobile phone.
